(19) United States
(12) Patent Application Publication
(10) Pub. No.: US 2021/0028808 A1
(43) Pub. Date: Jan. 28, 2021

(54) Phone Spinner

(71) Applicant: Jae Ho Kim, Fresh Meadows, NY (US)

(72) Inventor: Jae Ho Kim, Fresh Meadows, NY (US)

(21) Appl. No.: 16/946,724

(22) Filed: Jul. 1, 2020

Related U.S. Application Data
(60) Provisional application No. 62/869,300, filed on Jul. 1, 2019.

(51) Int. Cl. H04B 1/3888; A45C 11/00; H04M 1/04

(52) U.S. Cl. CPC H04B 1/3888; A45C 2011/002; H04M 1/04; A45C 11/00

(57) ABSTRACT

An adaptible mobile phone case and spinner includes a main body, a bearing-mounting nipple, a bearing, a cap on said bearing, a knob with a through bore on the surface of said cap, and a pinch clip attached to said knob. The bearing on the top corner is attached in a manner where its axis of rotation is a diagonal line across the front of the mobile phone case, in order that one may hold the phone upright by the pinch clip while balancing the mobile phone case by the bottom corner opposite of which it is being held on a flat surface such as a table. Holding the mobile phone case in the manner thus described allows the phone to spin freely.

### FIELD OF THE INVENTION

Today spinning fidget toys are well known and used by adults and children alike. These toys have been proven to have calming and therapeutic effects, particularly for individuals with anxiety. A plethora of toys and small gadgets have been designed specifically for that purpose. Many of these, however are easily lost because of their small and portable nature. Phones are constantly in people's hands. Because of that, a mobile phone case is an excellent candidate in which to incorporate a spinning or fidget toy.

The remedy of incorporating this need to fidget into a phone case comes with many problems of its own. First and foremost, it cannot interfere with charging the phone; this includes both wired and wireless charging methods. The ports to the phone and its buttons cannot be impeded. Wireless charging of most cell phones is achieved by the interface on the back of the phone when it makes contact with a charging pad. Therefore, any cases which place a toy or the like on the back of the phone pose a problem with its charging abilities

To deal with these problems, the present invention provides a phone case incorporated with a spinning apparatus which allows the user to spin or rotate the phone as desired. It does not impact the phone's charging, access to its ports or the ergonomics of the phone when held in hand while maintaining a discrete and accessible fidget device at the user's fingertips by incorporating it into their phone.

### SUMMARY OF THE INVENTION

The principal object of the present invention is to provide a spinning or rotating device incorporated into the mobile phone case of the user.

Another object of the present invention is to provide a fidget device incorporated into a phone case, which can be pinched or gripped by the user at a single contact point, while it spins or rotates by the single contact point.

A further object of the present invention is to provide a fidget device incorporated into a phone case, which has a base which can be rested on a surface and a pad on which the user places their finger diagonally across the phone between which the phone spins or rotates.

Yet another object of the present invention is to provide a spinner-bearing phone case capable of housing a cell phone, without impeding or blocking any of the cell phone functions, while simultaneously permitting the user of the cell phone to use it as a spinner toy.

These and other objects, advantages, features, and characteristics of the invention will be apparent from the following description of the preferred embodiments, considered along with the accompanying drawings.

While particular embodiments of the invention have been illustrated and described in detail herein, they are provided by way of illustration only and should not be construed to limit the invention. Since certain changes may be made without departing from the scope of the present invention, it is intended that all matter contained in the above description, or shown in the accompanying drawings be interpreted as illustrative and not in a literal sense. Practitioners of the art will realize that the sequence of steps and the embodiments depicted in the figures can be altered without departing from the scope of the present invention and that the illustrations contained herein are singular examples of a multitude of possible depictions of the present invention.

### BRIEF DESCRIPTION OF THE DRAWINGS

It is believed that the present invention will be better understood from the following detailed description taken in conjunction with the accompanying drawings, in which numerals represent identical elements and wherein:

FIG. 1 is a three dimensional perspective of the inventive phone spinner;

FIG. 2 is a front plan view of the inventive phone spinner of FIG. 1;

FIG. 3 is a first side view of the inventive phone spinner of FIG. 2;

FIG. 4 is another side view of the inventive phone spinner of FIG. 2;

FIG. 5 is a bottom view of the inventive phone spinner of FIG. 2;

FIG. 6 is a top view of the inventive phone spinner of FIG. 2;

FIG. 7 is an exploded three dimensional perspective of the inventive spinner-bearing phone case of FIG. 1;

FIG. 8 is an enlarged view of the spinner of FIG. 7 denoted by circle A;

FIG. 9 is a three dimensional perspective of the pinch clip set forth in FIG. 8;

FIG. 10 is a front view of the pinch clip of FIG. 9

FIG. 11 is a bottom view of the pinch clip in FIG. 9;

FIG. 12 is a top view of the pinch clip of FIG. 9;

FIG. 13 is a side view of the pinch clip of FIG. 9;

FIG. 14 is a three dimensional perspective of the cap of FIG. 8;

FIG. 15 is a front view of the cap of FIG. 14;

FIG. 16 is a top view of the cap of FIG. 15;

FIG. 17 is a bottom view of the cap of FIG. 15; and

FIG. 18 is a side view of the cap of FIG. 15

### LIST OF ELEMENTS AND THEIR RESPECTIVE IDENTIFYING NUMERALS

### NO ELEMENT

10 phone Spinner
20 phone case
30 spinner
31 bearing-mounting nipple
32 cap
33 knob
34 bearing-receiving cavity
35 bearing
36 pinch Clip
37 pin
38 knob through-bore
39 secondary through bores

### DETAILED DESCRIPTION

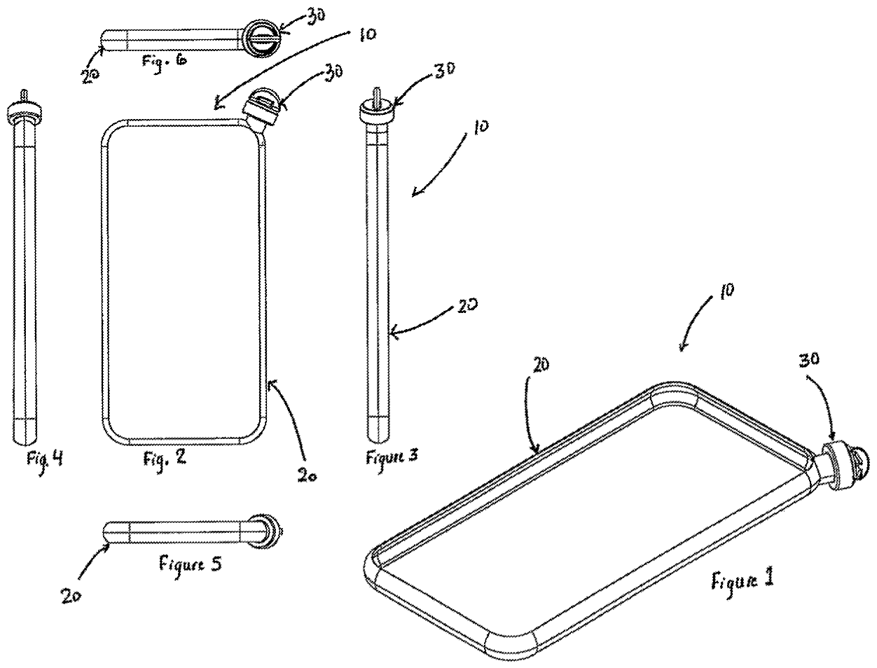

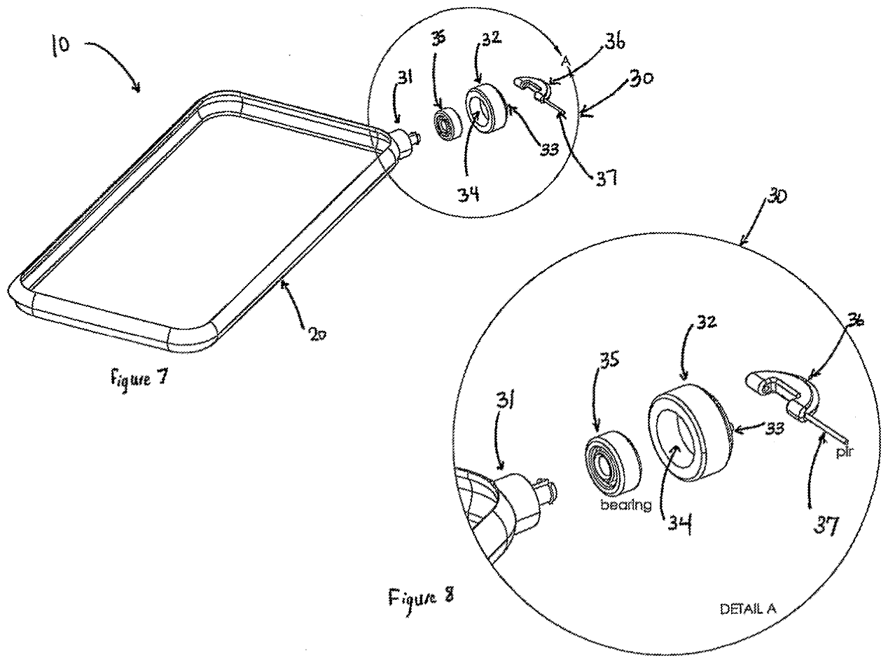

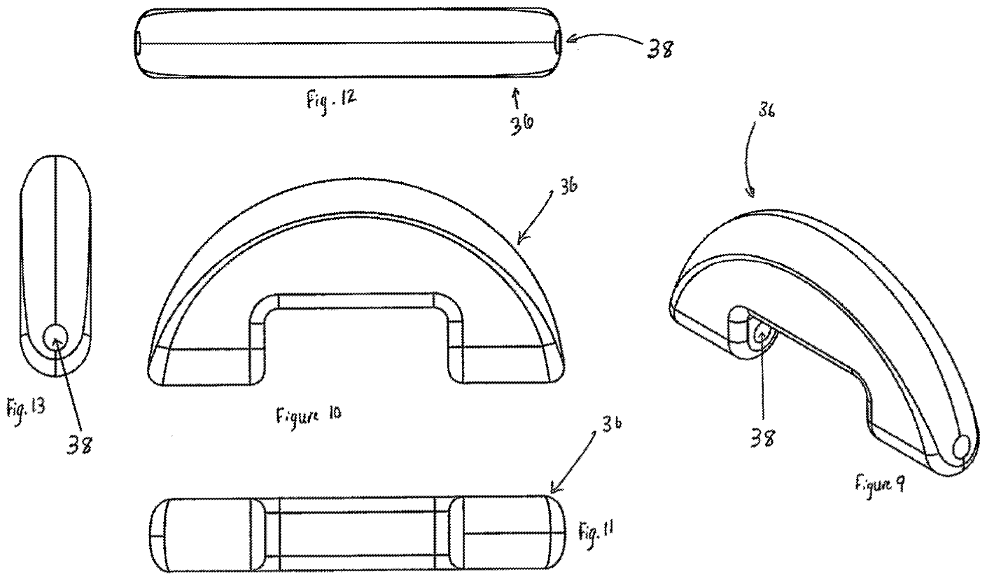

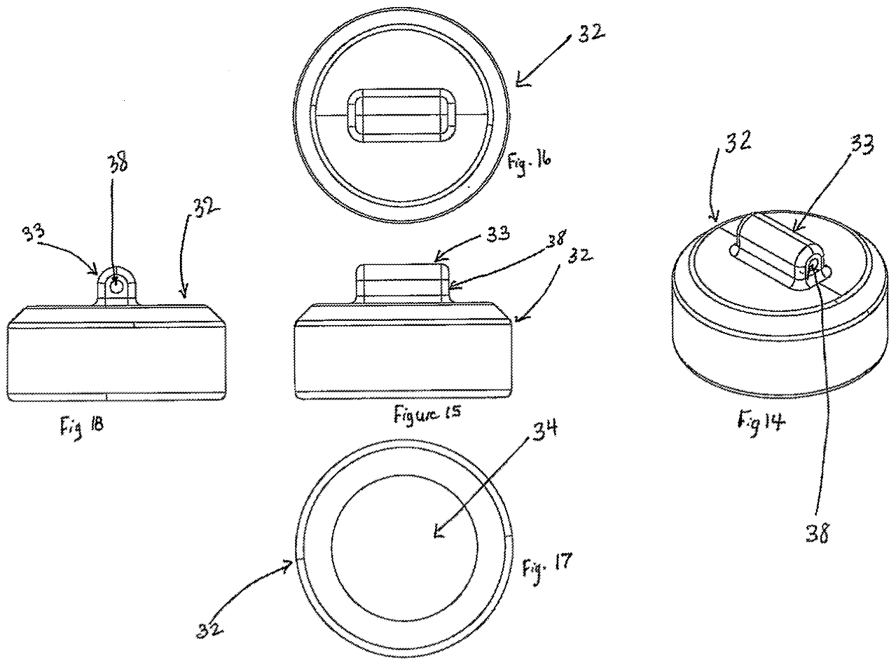

Referring more specifically to FIGS. 1-7, they generally depict at 10, at least one of the embodiments of the inventive phone spinner. In use, a phone is inserted into said phone spinner 10. Then the phone spinner is held by its spinning contact point, and it is either suspended freely, or allowed to touch a flat surface on its corner diagonally opposite the phone spinner's contact point. Thereafter a twisting force is applied to the phone and the phone starts spinning.

The inventive phone spinner 10 comprises a phone case 20 and a spinner 30 mounted on the phone case 20. In one embodiment of the inventive phone spinner 10, the spinner 30 is located on one of the four exterior corners of the phone case 20, preferably the top right corner of the phone case 20 such that when a phone, as for example a cell phone, is inserted into said phone case 20, the screen of the cell phone is primarily oriented right side up, facing its user.

The spinner 30 comprises a bearing-mounting nipple 31 fixedly attached to said phone case 20, a cap 32 having a top and a bottom, and a bearing 35. The top of said cap 32 is shaped to provide a grip point capable of acting as a knob 33. The bottom of said cap 32 defines a bearing-receiving cavity 34. The bearing 35 is fixedly mounted within said bearing-receiving cavity 34 of said cap 32 such that the bearing 35 is secured within said cap 32 while simultaneously being able to freely spin and allow rotation of the phone case 20 to occur, when the cap 32, containing said bearing 35 within its bearing-receiving cavity 34, is placed on said bearing mounting nipple 31, which is fixedly attached to said phone case 20. The spinner 30 further comprises a pinch clip 36 and a pin 37. The knob 33 of said cap 32 is provided with a through bore 38. The pinch clip 36 is provided with two secondary through bores 39, one on each arm of said pinch clip 36.

To assemble the phone spinner 10, said spinner 30 is mounted on said phone case 20, by fixedly mounting the cap-held-bearing 35, on said bearing-mounting nipple 31. Thereafter, securedly attaching said pinch clip 36 to said cap 32 by inserting the knob of 33 of the cap 32 into the space defined by the two arms of the pinch clip 36 such that the knob of 33 is juxtaposed with the arms of said pinch clip 36 and the secondary through bores 39 are collinear with the knob through bore 38. The pinch clip 36 is then secured to the cap 32 by threading the pin 37 through the collinearly arranged knob through-bore 38 of the cap 32 and secondary through-bores 39 of the pinch clip 36. The secured pinch clip 36 together with the knob 33 form a short pinch handle on said cap 32, from which a cell phone user can hold or suspend the phone spinner 10 and apply a torque to spin the phone once it is inserted into the phone case, is balanced on the bottom corner on top of a flat surface while being held by the pinch clip in an upright position, such that the axis of rotation is perpendicular to said flat surface.

In a second embodiment of the inventive phone spinner 10, the phone case 20 is provided with 2 spinners 30 on two exterior corners of the phone case 20, placed diagonally at both one corner at the top of the phone and the opposite corner of the bottom of the phone. The top corner spinner 30 is provided with a bearing 35 within the cap 32. The cap 32 and the pinch clip 36 form a pad on top, on which the finger of the user is placed during the rotation. The bottom corner spinner 30 acts as a base. The base cap 32 and pinch clip 36 attached thereto will act as a contact point between the phone case and a flat surface on which the rotation may occur. The base cap contact point can optionally have a surface grip such that the contact point does not slide on the surface which it rests.

In a third embodiment of the invention, the phone spinner 10 may comprise spinners 30 on all exterior corners of the phone case 20. All of said corners could incorporate pinch clips 36, or the two bottom corners could incorporate bases while the two top corners could incorporate pads. Alternatively, two diagonal top and bottom corners could be formatted as in the second embodiment of the invention and the remaining two corners would have pinch clips.

A fourth embodiment of the invention could comprise spinning apparatuses incorporated into three exterior corners of the phone case. Two diagonal top and bottom corners could be formatted as in the second embodiment of the invention with a third corner having a pinch clip.

What is claimed is:

1. An adaptable mobile phone case, comprising:
a. A main body;
b. A phone cavity, which is a cavity in the front side of the main body, wherein the phone cavity can contain a mobile phone;
c. A bearing attached to a top corner of the main body such that its axis of rotation is a diagonal line across the length of the mobile phone case;
d. A cap covering said bearing;
e. A knob with a through bore fixed to the surface of said cap;
f. A pinch clip with a through bore, attached to said knob by means of a pin through the through bores of the pinch clip and knob;
Wherein one may hold the mobile phone case by the pinch clip while balancing the mobile phone case by the bottom corner opposite of which it is being held on a flat surface such as a table, such that holding the mobile phone case in the manner thus described allows the phone to spin freely on said axis of rotation.

2. The adaptable mobile phone case of claim 1, wherein the bottom corner opposite of the bearing on the top corner has an identical spinning apparatus comprising a bearing, cap, knob, pin and pinch clip, enabling the user to hold the mobile phone case by each pinch clip using each hand, thus allowing the mobile phone to be spin without the need of a flat surface on which to balance upon.

3. The adaptable mobile phone case of claim 2, wherein the cap located on bottom corner has a surface that is texturized and/or of a rubberized material in lieu of said knob, pin and pinch clip such that the bottom corner does not slide on the surface which it rests.

4. An adaptable mobile phone case, comprising:
a. A main body;
b. A phone cavity, which is a cavity in the front side of the main body, wherein the phone cavity can contain a mobile phone;
c. A bearing attached to any corner of the main body such that its axis of rotation is a diagonal line across the length of the mobile phone case;
d. A cap covering said bearing;
e. A knob with a through bore fixed to the surface of said cap;
f. A pinch clip with a through bore, attached to said knob by means of a pin through the through bores of the pinch clip and knob;
Wherein one may hold the mobile phone case by the pinch clip while balancing the mobile phone case by the corner opposite of which it is being held on a flat surface such as a table, such that holding the mobile phone case in the manner thus described allows the phone to spin freely on said axis of rotation.

5. An adaptable mobile phone case, comprising:
a. A main body;
b. A phone cavity, which is a cavity in the front side of the main body, wherein the phone cavity can contain a mobile phone;
c. A spinning apparatus attached to any corner of the main body such that its axis of rotation is a diagonal line across the length of the mobile phone case;
d. A holding apparatus attached in a hinging manner to said spinning apparatus such that the user can maintain a grip on the spinning-apparatus-equipped corner of the mobile phone case while spinning the mobile phone
Wherein one may hold the mobile phone case by the holding apparatus while balancing the mobile phone case by the corner opposite of which it is being held on a flat surface such as a table, such that holding the mobile phone case in the manner thus described allows the phone to spin freely on said axis of rotation.
